(19) United States
(12) Patent Application Publication
(10) Pub. No.: US 2026/0057643 A1
(43) Pub. Date: Feb. 26, 2026

(54) IMAGING REFERENCE ARRANGEMENTS

(71) Applicant: Canfield Scientific, Incorporated, Parsippany, NJ (US)

(72) Inventors: Douglas C. Canfield, Millburn, NJ (US); Sachin V. Patwardhan, Parsippany-Troy Hills, NJ (US)

(73) Assignee: Canfield Scientific, Incorporated, Parsippany, NJ (US)

(21) Appl. No.: 19/288,997

(22) Filed: Aug. 2, 2025

Related U.S. Application Data
(60) Provisional application No. 63/681,051, filed on Aug. 8, 2024.

(51) Int. Cl. G06V 10/74; G06T 7/50

(52) U.S. Cl. CPC G06V 10/761; G06T 7/50

(57) ABSTRACT

Arrangements are disclosed which provide reliable and accurate image ranging, orientation, and/or color referencing. In exemplary implementations, an image reference marker is arranged at or proximate to an area to be imaged. A display shows a live view of the area with a matching pattern superimposed thereon as a user positions the image capture device to align the image of the marker with the matching pattern. Once satisfactory alignment is achieved, an image of the area can be captured manually or automatically.

### RELATED APPLICATIONS

This application claims priority from U.S. Provisional Patent Application No. 63/681,051 filed Aug. 8, 2024 and incorporated herein by reference in its entirety.

### BACKGROUND INFORMATION

In various imaging applications, such as the imaging of skin, for example, it is often desirable for the imaged area to be at a fixed distance, or range, from the imaging device. Additionally, it is often desirable for the plane of the imaging surface of the imaging device, such as the plane of the device's imaging sensor, to be oriented parallel to a plane of the imaged area, to the extent that the imaged area can be approximated as planar, or substantially planar.

One approach has been to employ Light Detection and Ranging (LIDAR) for positioning, ranging, and orientation. The employment of technologies such as LIDAR, however, entails additional complexity, energy consumption, and cost, among other drawbacks, which may make their inclusion in some implementations undesirable, impractical, or unworkable.

Arrangements that can effectively provide both range and orientation referencing without the drawbacks of other approaches, such as the aforementioned, are lacking.

### SUMMARY OF THE DISCLOSURE

Arrangements that can provide both range and orientation referencing in imaging are disclosed.

In exemplary implementations, arrangements that can also provide color referencing are disclosed.

The disclosure relates to an apparatus comprising:
processing circuitry coupled to a display device and an image capture device and being configured to:
   obtain from the image capture device an image of skin, the skin having on it a feature of interest and a reference feature, wherein the feature of interest and the reference feature appear in the image;
   cause the display device to display the image with a matching pattern superimposed thereon;
   repeat the obtaining and the displaying of the image during relative movement between the image capture device and the skin;
   determine that an appearance of the reference feature in the image matches the matching pattern; and
   perform an action based on the determination that the appearance of the reference feature in the image matches the matching pattern.

According to an embodiment of the disclosure, the appearance of the reference feature in the image has a shape and two dimensions and matches the matching pattern if at least the shape matches a shape of the matching pattern or the two dimensions match two dimensions of the matching pattern.

According to a further embodiment of the disclosure, performing an action includes at least one of:
generating an indication,
receiving a user input, or
storing information relating to the image, the information including one or more of a still of the image or a metric.

According to another embodiment of the disclosure, the relative movement includes at least one of a translation or a rotation of the image capture device or the skin.

According to further embodiment of the disclosure, the reference feature has an opening and the feature of interest is located within the opening.

According to yet another embodiment of the disclosure, the processing circuitry is configured to process the image to include the matching pattern in the image.

According to further embodiment of the disclosure, the matching pattern is based on the reference feature.

According to another embodiment of the disclosure, the reference feature includes at least one reference color.

According to further embodiment of the disclosure, the reference feature includes a sticker, a label, a decal, a tattoo, or a skin feature.

According to further embodiment of the disclosure, the apparatus comprises at least one of the display device or the image capture device.

The disclosure further relates to a method comprising:
capturing with a device an image of skin, the skin having on it a feature of interest and a reference feature, wherein the feature of interest and the reference feature appear in the image;
displaying the image with a matching pattern superimposed thereon;
repeating the capturing and the displaying of the image during relative movement between the device and the skin;
determining that an appearance of the reference feature in the image matches the matching pattern; and
performing an action based on the determination that the appearance of the reference feature in the image matches the matching pattern.

According to an embodiment of the method of the disclosure, the appearance of the reference feature in the image has a shape and two dimensions and matches the matching pattern if at least the shape matches a shape of the matching pattern or the two dimensions match two dimensions of the matching pattern.

According to a further embodiment of the method of the disclosure, performing an action includes at least one of:
generating an indication,
receiving a user input, or
storing information relating to the image, the information including one or more of a still of the image or a metric.

According to another embodiment of the method of the disclosure, the relative movement includes at least one of a translation or a rotation of the device or the skin.

According to a further embodiment of the method of the disclosure, displaying the image is performed using a display of the device.

According to further embodiment of the method of the disclosure, the method comprises processing the image to include the matching pattern in the image.

According to yet another embodiment of the method of the disclosure, the matching pattern is based on the reference feature.

According to an embodiment of the method of the disclosure, the reference feature includes at least one reference color.

According to a further embodiment of the method of the disclosure, the reference feature includes a sticker, a label, a decal, a tattoo, or a skin feature.

The disclosure further relates to a non-transitory computer-readable storage medium containing instructions executable by a computer to perform the method as described above.

These and other aspects of such apparatuses and methods and exemplary variants thereof are described in greater detail herein.

### BRIEF DESCRIPTION OF THE DRAWINGS

A more complete understanding of the present disclosure may be realized by reference to the accompanying drawings.

FIGS. 1A-1C relate to a first exemplary implementation in accordance with the present disclosure.

FIGS. 2A-2C relate to a second exemplary implementation in accordance with the present disclosure.

FIG. 3 shows exemplary image reference markers in accordance with the present disclosure.

FIGS. 4A-4D show illustrative images with various magnifications.

FIG. 5 is a flowchart of an exemplary method in accordance with the present disclosure.

FIG. 6 is a schematic representation of an exemplary system in accordance with the present disclosure.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope. More particularly, while numerous specific details are set forth, it is understood that embodiments of the disclosure may be practiced without these specific details and in other instances, well-known circuits, structures, and techniques have not been shown in order not to obscure the understanding of this disclosure.

Furthermore, all examples and conditional language recited herein are principally intended expressly to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the drawings herein represent conceptual views of illustrative structures embodying the principles of the disclosure.

In addition, it will be appreciated by those skilled in art that any flowcharts, flow diagrams, and the like represent various processes which may be substantially represented in a computer readable medium and so executed by a computer or processor, whether or not such computer or processor is explicitly shown.

The functions of the various elements shown in the drawings, including any functional blocks, steps, procedures, modules, units or the like may be provided through the use of dedicated hardware as well as hardware capable of executing software. When provided by a processor, the functions may be provided by a dedicated processor, by a shared processor, or by a plurality of processors, some of which may be shared. Moreover, explicit use of the term “processor” or “controller” should not be construed to refer exclusively to hardware capable of executing software, and may implicitly include, without limitation, dedicated circuitry, digital signal processor (DSP) hardware, network-based processors, application specific integrated circuitry (ASIC), read-only memory (ROM), random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

As used herein, the term “image” may encompass any form of photo-documentation, including, for example: 2D images and/or 3D surfaces and/or 3D volumetric image data, where a 2D image could be a single or a multichannel visible impression obtained by a camera, a 3D surface could be points in a 3D space connected by line segments to form a polygonal mesh along with any associated 2D images that represent the underlying texture and a 3D volumetric image data might represent a stack of 2D images that represent a 3D volume of the object being imaged, such as a stack of MRI images; moving images, video, and/or one or more frames or pictures thereof. The term “image” as used herein may also refer to the results of processing one or more captured images to derive a further image.

Exemplary implementations of imaging reference arrangements will now be described.

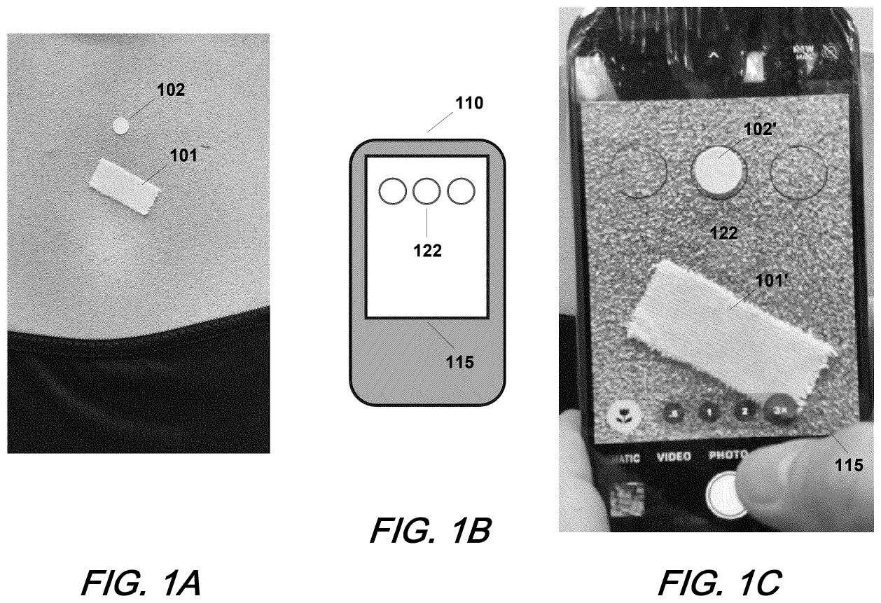

FIG. 1A is an illustrative representation of an area 101 to be imaged, such as an area of skin. An image reference marker 102 is placed proximate to area 101. In an exemplary implementation, marker 102 has a circular shape with a diameter of 5 mm. Area 101 may have one or more features of interest for which imaging is desired, such as for example one or more lesions, wrinkles, pores, hairs, or anatomical structures, among others. In exemplary implementations, marker 102 does not occlude or overlap area 101.

FIG. 1B is a schematic representation of an exemplary device 110, such as a smartphone having a camera. Device 110 has a display 115, such as a touchscreen, which can show a live view of an image captured by the camera of the device, such as when a camera application or the like is executed on device 110. As shown in FIG. 1B, one or more matching patterns 122 are shown on display 115, overlaid on the live view. In the exemplary implementation of FIG. 1B, three circular matching patterns 122 are shown, each having a diameter of 10 mm. Matching pattern(s) 122 can be provided on a transparent label or the like that is placed over display 115 or they can be generated by device 110 and displayed concurrently with the live view on display 115.

FIG. 1C depicts an image capture operation using device 110 to capture an image of area 101 and image reference marker 102. While viewing area 101 and marker 102 on display 115 of device 110, a user attempts to position device 110, such as by translation and/or rotation of the device, so that the image 102′ of marker 102 as it appears on display 115 aligns with one of matching pattern(s) 122 overlaid on the live view. Once thus aligned to the user's satisfaction, the user can then press an image capture icon, button, or the like to cause the device to capture an image of the live view displayed (e.g., a frame of video). Alternatively, device 110 can be programmed to automatically capture an image once the alignment has met one or more criteria, such as, for example, criteria related to how closely the shape and size of the image 102′ of the marker match pattern 122. For example, if the plane of the imaged surface is not parallel with the image capture plane of the camera of device 110, image 102′ of marker 102, which in this example is circular, will appear elliptical. One criterion can be whether the major and minor radii of this elliptical shape and of the radius of matching pattern 122 are within some tolerable range of ratios to each other, e.g., 0.95-1.05, for example. Other criteria can be used for markers of different shapes, such as those described below.

As can be appreciated, because marker 102 is used as a reference for imaging area 101, it is preferable, in exemplary implementations, that their relative locations are such that marker 102 and area 101 are in the same, or practicably the same, plane and distance from the image capture device (e.g., camera of device 110).

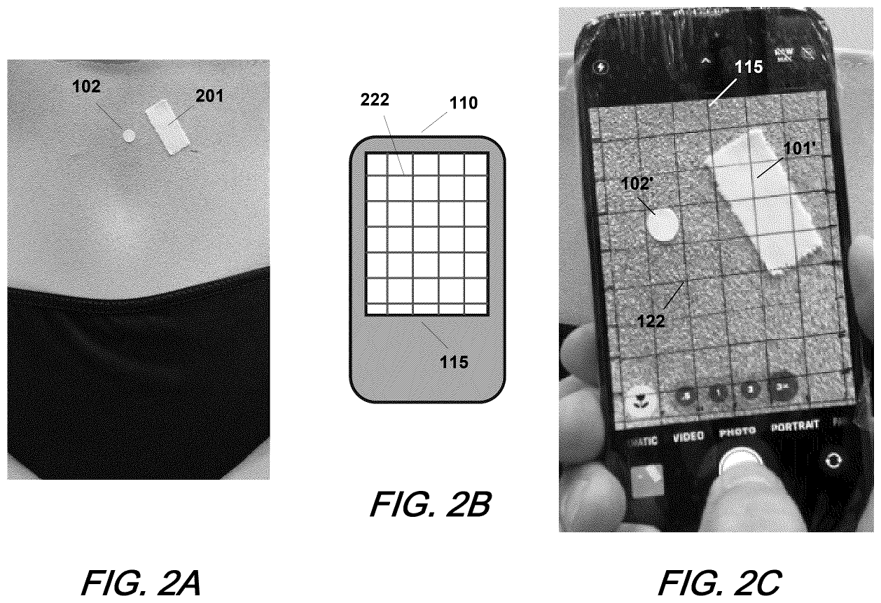

FIG. 2A is an illustrative representation of an area 201 of skin to be imaged. An image reference marker 102 is placed proximate to area 201. In an exemplary implementation, marker 102 has a circular shape with a diameter of 5 mm.

FIG. 2B is a schematic representation of device 110 with a matching pattern 222 shown on display 115, overlaid on the live view. In the exemplary implementation of FIG. 2B, matching pattern 222 is a grid with lines uniformly spaced 10 mm horizontally and vertically.

FIG. 2C depicts an image capture operation using device 110 to capture an image of area 201 and image reference marker 102. While viewing area 201 and marker 102 on display 115 of device 110, a user attempts to position device 110 so that the image 102′ of marker 102 as it appears on display 115 aligns with matching pattern 222 overlaid on the live view. In this case, alignment may entail having the perimeter of image 102′ tangential with the four grid lines defining a box of the grid, as depicted in FIG. 2C.

It should be noted that while areas 101, 201 are shown as generally rectangular in shape for illustrative purposes, area 101 or 102 can be of any shape, such as the shape of a skin feature with irregular borders, for example.

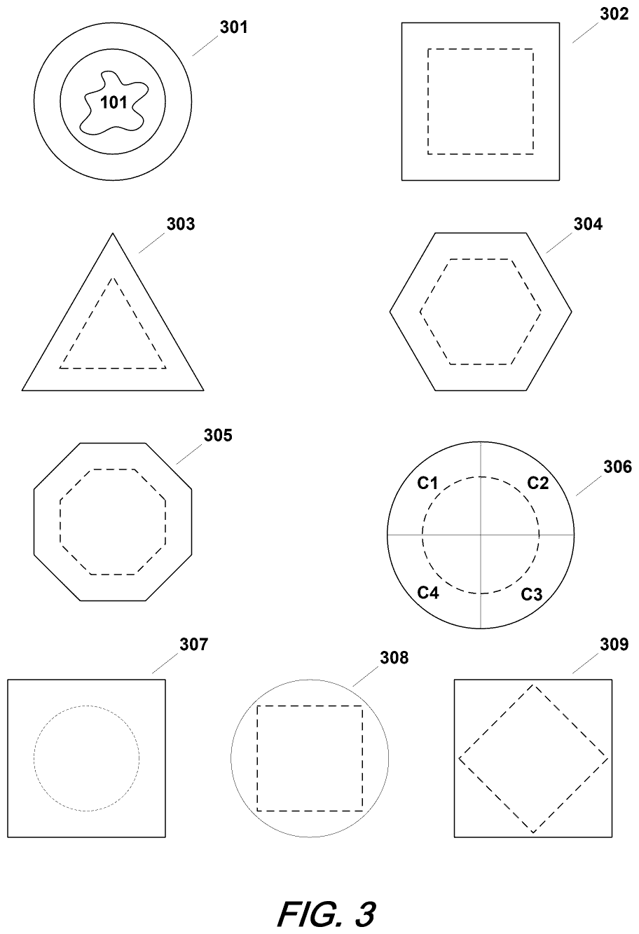

A variety of further exemplary image reference markers 301-309 are shown in FIG. 3. Marker 301 is implemented with a circular perimeter and a circular opening, thereby forming a ring that can be placed around an area 101 to be imaged. Other suitable shapes are also contemplated, such as those of 302-309, without limitation. Optional openings for markers 302-309 are depicted with dashed lines.

Note that in exemplary implementations of image reference markers having openings, the opening can be used for referencing purposes in addition to or instead of the outer perimeter of the marker. Furthermore, the shape and/or orientation of the opening need not be the same as that of the outer perimeter, as exemplified by markers 307-309.

In addition to acting as an aid for range and orientation referencing, an image reference marker, such as exemplary marker 306, can also be configured for intensity and/or color referencing. As shown in FIG. 3, marker 306 is configured as a circle (or ring) with four sectors, each having a respective reference color C1-C4, such as White, Red, Green, and Blue, for example. Other marker shapes, colors, numbers of colors, and arrangement and shapes of colored sections are contemplated by the present disclosure. Moreover, multiple markers, each with different colors or sets of colors, can be used in an imaging arrangement. In exemplary implementations, the one or more reference colors include one or more standard colors having known color characteristics.

In illustrative applications, such a marker can be used to calibrate and/or correct images captured with the marker appearing therein. In exemplary implementations, such markers may have spectral reflectances intended to mimic those of natural objects, such as human skin for example, have consistent color appearance under a variety of lighting conditions, especially as detected by typical color cameras, and be stable over time, e.g., between two or more sequential images of an area of interest captured over some observation time interval, such as hours, days, weeks, months, or years, depending on the application.

The color/intensity values of the various sections of a reference marker such as marker 306 can be measured from the captured image and compared with the expected values to determine any difference(s). Based on such difference(s) the captured image can be corrected/calibrated accordingly. Such a reference marker can also be used to color correct one image with the reference color marker in it (that may have a different color cast, for example due to a lighting coloration difference) to another, reference image with the reference color marker in it.

In exemplary implementations, image reference markers can be provided with alphanumeric, graphic, and/or color-coded information thereon. Such information may include, for example, bar- and/or QR-codes which can be detected by device 110 and used to obtain additional information. The information associated with a marker can be associated with the image area 101 proximate to the marker and provide various items of information regarding the image area.

A marker 102 may also be configured to act as a rotation orientation reference. For example, an exemplary marker may have the shape of an arrow, some asymmetry, a label with an arrow, or some other suitable indication of orientation. The relative positions of 101 and 102 and/or the shape of image area 101 may also provide orientation.

In exemplary implementations, multiple markers can be used in an image, including markers with different shapes and/or information thereon. Moreover, various shapes and arrangements of matching patterns, in addition to those shown, can be used, including for example, matching patterns with shapes and/or grids that coincide with those of the marker(s) used in an image. For example,

A suitable size for a marker can be based on the size of the skin area to be imaged. For example, when imaging a typical skin lesion, a suitable marker size could be 5 mm (as in the illustrative implementations discussed above) whereas when capturing a half-body image, a suitable marker size could be 25 mm. Preferably, the size of the marker should be generally proportionate to the size of the area imaged so as to ensure that the marker is clearly visible in the image.

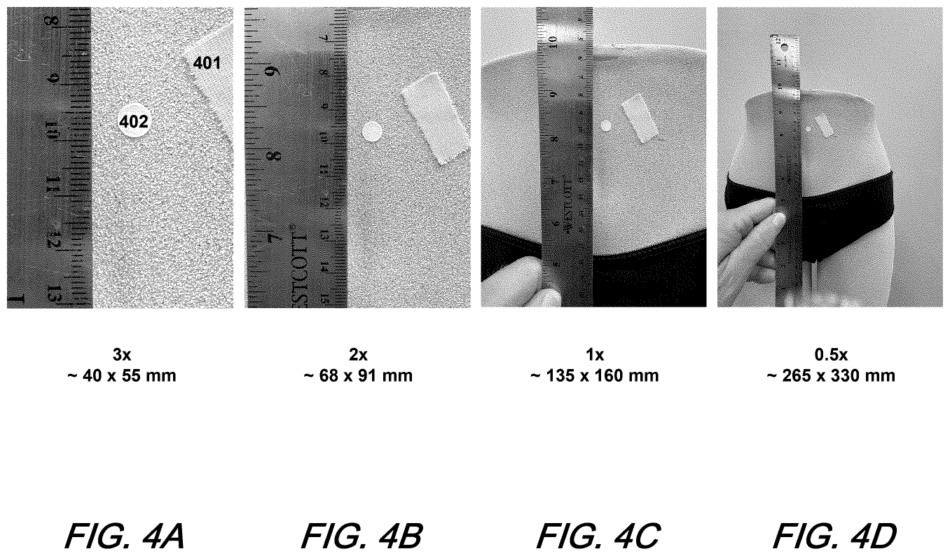

FIGS. 4A-4D show four images of an illustrative arrangement of an area 401 and marker 402 captured with the same subject-to-camera distance (e.g., approximately 14 cm) at 3×, 2×, 1×, and 0.5× magnification, respectively. The horizontal and vertical extents of the areas imaged are indicated for the respective magnifications. The circular marker 402 has a diameter of 5 mm.

For a given imaging device, it is preferred to capture the image at the focal length distance or within the depth-of-field of the device. For the expected subject-to-camera distance, the resolution of the imaging device (e.g., number of pixels per centimeter) can be determined, such as by capturing an image of a scale from the expected distance and measuring the number of pixels within a given distance, e.g., one centimeter. The resolution value can then be used to translate the marker size into a number of pixels. For example, if the marker is a 5 mm diameter circle and the resolution of the imaging device is 100 pixels per centimeter, then the 5 mm diameter would be 50 pixels. Then for displaying the marker matching pattern on the screen of the device, the display resolution can be used to scale the pattern accordingly.

In exemplary implementations, an image reference marker can be a sticker, label, decal, or the like that can be applied to the area to be imaged. In other implementations, an image reference marker can be a tattoo or the like, which can be applied for purposes of the imaging and later removed or which can fade.

In exemplary implementations, a pre-existing tattoo or other visible skin feature, preferably one that is not expected to significantly change between sequential images of an area of skin, may be used as an image reference marker. In such implementations, an image with the feature with desired positioning (e.g., the plane of the imaged surface being parallel with the image capture plane of the camera, at a desired distance) is captured. The image is processed to generate a matching pattern based on the feature, such as, for example, an outline or a silhouette of the feature. The matching pattern thus generated, can then be displayed on the device 110 and used for image referencing by alignment with a live view of the feature, as in the case of the other exemplary reference markers 102 and matching patterns 122 described above.

In exemplary implementations, when capturing a follow-up image of an area of interest, a previously captured image, e.g., a baseline image, can be superimposed on the live preview of the follow-up image. This feature can be used, for example, to guide the positioning of the device 110 and/or area to match the previously captured image of the area. It can also be used for positioning the marker in or approximately in the same position as in the previous image. This feature can be particularly useful when the imaged area is not flat. In exemplary implementations, when a first, baseline, image of an area is captured, a marker and a matching pattern, as described above, can be used. When capturing a subsequent, follow-up, image of the area, the live view of the area can be displayed with the matching pattern and the baseline image, with just the baseline image, or with just the matching pattern superimposed on the live view.

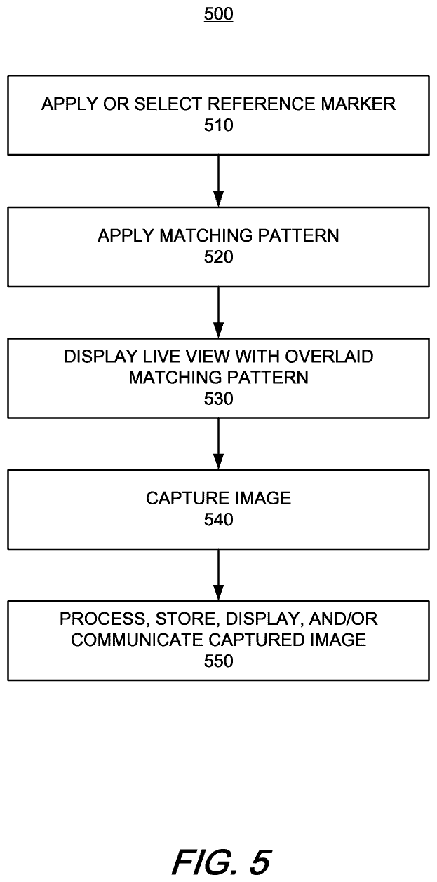

An exemplary method relating to imaging reference arrangements such as described herein, will now be described with reference to FIG. 5, which shows a flowchart depicting an exemplary method 500. As shown in FIG. 5, operation begins at 510 in which a reference marker, such as marker 102 described above, is applied to a surface, or selected on the surface, proximate to an area 101 on the surface to be imaged.

At 520 of method 500, a matching pattern, such as pattern 122 described above, is applied. As discussed above, this may entail attaching an overlay with the matching pattern onto the display 115 of the device 110 to be used for the imaging to be carried out. In exemplary implementations, the matching pattern 122 may be generated and displayed based on the operation of an application running on device 110. Where markers of various shapes and/or configurations are possible, the user may select a matching pattern having a shape matching that of the marker used, such as from a menu of different matching patterns. In exemplary implementations, the device may automatically select a matching pattern by capturing an image of the marker and performing an image recognition procedure to find a matching pattern whose shape best or satisfactorily matches that of the marker. In exemplary implementations, where markers of different sizes may be used, their size can be indicated on the markers, which the device can recognize, or the user may enter or select the size, among other possibilities.

At 530 of method 500, a live view of area 101 and reference marker 102 with matching pattern 122 superimposed thereon is displayed, such as on display 115 of device 110. During 530, the user can position device 110 to align the appearance 102′ of the marker and 122. To aid in this process, the user can be guided, such as with instructions or cues displayed or audibly output, for example, by device 110.

At 540 of method 500, an image is captured. As discussed above, this can be done, for example, based on user input or automatically by the device 110.

At 550, the captured image can be processed, stored, displayed, and/or communicated, for example.

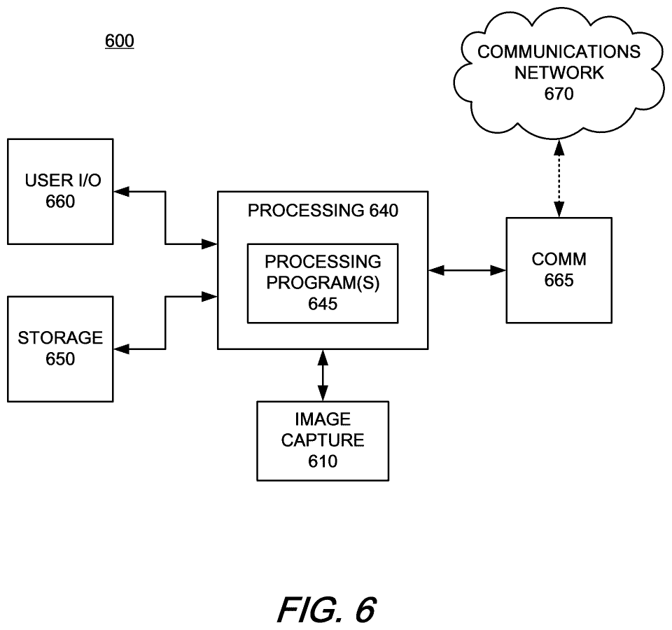

Turning now to FIG. 6, there is shown in schematic form an exemplary imaging system 600 in accordance with the present disclosure. As shown in FIG. 6, components of system 600 include an image capture apparatus 610 coupled to processing circuitry 640. Image capture apparatus 610 may include, for example: a camera; a dermatoscope with image capturing capabilities, such as Canfield Scientific Inc.'s VISIOMED D200EVO and VEOS DS3; or a mobile device with image capturing capabilities, such as a smartphone or tablet computer, with or without attachment(s) for providing imaging as described herein.

Images captured by image capture apparatus 610 are provided to processing circuitry 640 for processing as described above. Processing circuitry 640 may also control image capture apparatus 610, for example, by controlling one or more aspects of the image capture and/or illumination of the subject, such as exposure, and modality, including, for example, which illumination mode to use, among others.

Images may also be provided to processing circuitry 640 from other sources and by other means. For example, images may be provided via communications network 670, or in a non-transitory storage medium, such as storage 650.

Processing circuitry 640 may be coupled to storage 650, for storing and retrieving images, among other data, and/or programs, software, and firmware, among other forms of processing instructions; and to input/output devices 660, such as a display device and/or user input devices, such as a keyboard, mouse, touchscreen, microphone, image capture device, or the like. Processing circuitry 640 may also be coupled to communications circuitry 665 for interconnection with a communications network 670, such as a local network and/or the Internet, for transmitting and receiving images and/or data, and/or receiving commands, software updates or the like. Processing circuitry 640, storage 650, I/O 660, and/or communications module 665 may be implemented, for example, with one or more computers, workstations, processors, or the like, operating in accordance with one or more programs 645 embodied in a compatible, non-transitory, machine-readable storage medium. Program(s) 645 may be stored in storage 650 and/or other memory devices (not shown), and provided therefrom and/or from communications network 670, via communications module 665, to processing circuitry 640 for execution. Methods in accordance with the present disclosure, such as method 500 described above with reference to FIG. 5, can be implemented by execution of one or more programs 645.

The various components of system 600 may be connected via any suitable wired or wireless connections. For example, image capture apparatus 610 may be a digital camera tethered to a computer/laptop 640/650/660/665 with a live preview of the camera image displayed on the screen of the computer/laptop, and a marker matching pattern 122/222 overlaid on said live preview.

It should be noted that the exemplary system 600 illustrates just one of a variety of possible arrangements contemplated by the present disclosure. For example, the various components of system 600 need not be co-located. For instance, image capture apparatus 610 and I/O devices 660 can be located in a practitioner's office and processing circuitry 640 and storage module 650 can be remotely located, functioning within a telehealth framework, or can be “cloud-based,” interacting with image capture apparatus 610 and I/O devices 660 over communications network 670. In other exemplary arrangements, I/O devices 660 can be remotely located from image capture apparatus 610, thereby allowing a user to remotely examine subjects' images, such as in a telehealth arrangement.

In other implementations, system 600 can be implemented with a portable or mobile computing device having image capture apparatus 610 integrated therein, such as a tablet computer, smartphone, a Canfield VEOS DS3 device, or the like, modified and/or programmed to operate as described herein.

The foregoing merely illustrates principles of the present disclosure and it will thus be appreciated that those skilled in the art will be able to devise numerous alternative arrangements which, although not explicitly described herein, embody the principles of the present disclosure and are within its spirit and scope. For instance, as can be appreciated, a variety of arrangements of processing and imaging systems and devices are contemplated consistent with the present disclosure. Additionally, although illustrated as single elements, each block or step shown may be implemented with multiple blocks or steps, or various combinations thereof. Also terms such as “software,” “application,” “program,” “firmware,” or the like, are intended to refer, without limitation, to any instruction or set of instructions, structure, or logic embodied in any suitable, non-transitory, machine-readable medium. It is to be understood that numerous modifications may be made to the illustrative s and that other arrangements may be devised without departing from the spirit and scope of the present invention as defined by the appended claims.

1. An apparatus comprising:
processing circuitry coupled to a display device and an image capture device and being configured to:
obtain from the image capture device an image of skin, the skin having on it a feature of interest and a reference feature, wherein the feature of interest and the reference feature appear in the image;
cause the display device to display the image with a matching pattern superimposed thereon;
repeat the obtaining and the displaying of the image during relative movement between the image capture device and the skin;
determine that an appearance of the reference feature in the image matches the matching pattern; and
perform an action based on the determination that the appearance of the reference feature in the image matches the matching pattern.

2. The apparatus of claim 1, wherein the appearance of the reference feature in the image has a shape and two dimensions and matches the matching pattern if at least the shape matches a shape of the matching pattern or the two dimensions match two dimensions of the matching pattern.

3. The apparatus of claim 1, wherein performing an action includes at least one of:
generating an indication,
receiving a user input, or
storing information relating to the image, the information including one or more of a still of the image or a metric.

4. The apparatus of claim 1, wherein the relative movement includes at least one of a translation or a rotation of the image capture device or the skin.

5. The apparatus of claim 1, wherein the reference feature has an opening and the feature of interest is located within the opening.

6. The apparatus of claim 1, wherein the processing circuitry is configured to process the image to include the matching pattern in the image.

7. The apparatus of claim 1, wherein the matching pattern is based on the reference feature.

8. The apparatus of claim 1, wherein the reference feature includes at least one reference color.

9. The apparatus of claim 1, wherein the reference feature includes a sticker, a label, a decal, a tattoo, or a skin feature.

10. The apparatus of claim 1, comprising at least one of the display device or the image capture device.

11. A method comprising:
capturing with a device an image of skin, the skin having on it a feature of interest and a reference feature, wherein the feature of interest and the reference feature appear in the image;
displaying the image with a matching pattern superimposed thereon;
repeating the capturing and the displaying of the image during relative movement between the device and the skin;
determining that an appearance of the reference feature in the image matches the matching pattern; and
performing an action based on the determination that the appearance of the reference feature in the image matches the matching pattern.

12. The method of claim 11, wherein the appearance of the reference feature in the image has a shape and two dimensions and matches the matching pattern if at least the shape matches a shape of the matching pattern or the two dimensions match two dimensions of the matching pattern.

13. The method of claim 11, wherein performing an action includes at least one of:
generating an indication,
receiving a user input, or
storing information relating to the image, the information including one or more of a still of the image or a metric.

14. The method of claim 11, wherein the relative movement includes at least one of a translation or a rotation of the device or the skin.

15. The method of claim 11, wherein displaying the image is performed using a display of the device.

16. The method of claim 11, comprising processing the image to include the matching pattern in the image.

17. The method of claim 11, wherein the matching pattern is based on the reference feature.

18. The method of claim 11, wherein the reference feature includes at least one reference color.

19. The method of claim 11, wherein the reference feature includes a sticker, a label, a decal, a tattoo, or a skin feature.

20. A non-transitory computer-readable storage medium containing instructions executable by a computer to perform the method of claim 11.
